(19) United States
(12) Patent Application Publication
(10) Pub. No.: US 2004/0099768 A1
(43) Pub. Date: May 27, 2004

(54) Aircraft, with means for at least reducing impact against the ground

(76) Inventors: Maryan Chak, Brooklyn, NY (US); Alexander Chak, Brooklyn, NY (US)

Correspondence Address: Ilya Zborovsky, 6 Schoolhouse Way, Dix Hills, NY, 11746, US

(21) Appl. No.: 10/300,962

(22) Filed: Nov. 22, 2002

(51) Int. Cl. B64D 17/00; B64D 19/00

(52) U.S. Cl. 244/139

(57) ABSTRACT

An aircraft, comprising a body; a structure providing flying of the aircraft; and a structure for preventing or at least reducing chances of crash of the aircraft in the event of malfunction, the preventing and reducing structure include a structure for preventing a direct hit of the body of the aircraft against a surface.

### BACKGROUND OF THE INVENTION

The present invention relates to aircrafts. It is known that aircrafts experience problems, malfunctions, etc. and sometimes crash with concomitant loss of life of their passengers.

It is known to provide some means for at least reducing impact against the ground, as disclosed for example in our patent application Ser. No. 10/054,191. Some means are also disclosed in U.S. Pat. Nos. 6,131,852, 5,944,282, 5,899,414, 6,042,051, 4,923,145, 5,356,097, 5,921,503, 576,778. It is believed that the existing aircrafts can be further improved to increase a probability of preventing or at least reducing the impact during the crash.

### SUMMARY OF THE INVENTION

Accordingly, it is an object of the present invention to provide an aircraft which is a further improvement of the existing aircrafts.

In keeping with these objects and with others which will become apparent hereinafter, one feature of the present invention resides, briefly stated, in an aircraft which has a body; means providing flying of the aircraft; and means for preventing or at least reducing chances of crash of the aircraft in the event of malfunction, said preventing and reducing means include a means for preventing a direct hit of the body of the aircraft against a surface.

The means for preventing a direct impact of the aircraft against the surface can be formed in accordance with the present invention as means creating a pressure under the aircraft, as explosive means, as a plurality of small explosive means, as a multi-part additional bottom, as an additional bottom provided with legs, as a plurality of bottoms moveable relative to one another, and also has an extendable and retractable helicopter-type propeller.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an aircraft in accordance with one embodiment of the present invention;

FIG. 2 is a view showing the aircraft in accordance with a second embodiment of the present invention;

FIG. 3 is a view showing the aircraft in accordance with a third embodiment of the present invention;

FIG. 4 is a view showing an aircraft in accordance with a fourth embodiment of the present invention;

FIG. 5 is a view showing an aircraft in accordance with a fifth embodiment of the present invention;

FIG. 6 is a view showing an aircraft in accordance with a sixth embodiment of the present invention;

FIG. 7 is a view showing an aircraft in accordance with a seventh embodiment of the present invention.

### DESCRIPTION OF THE PREFERRED EMBODIMENTS

An aircraft in accordance with the present invention, formed for example as an airplane has a body which is identified as a whole reference numeral 1. It is also provided with means for flying the aircraft, which are not shown since they are well known in the art, for example has corresponding engines.

In accordance with the present invention, the aircraft is provided with means for at least reducing impact against the ground or preventing at least partially a crash of the aircraft against the ground. The preventing means in accordance with various embodiments of the present invention are formed in different ways.

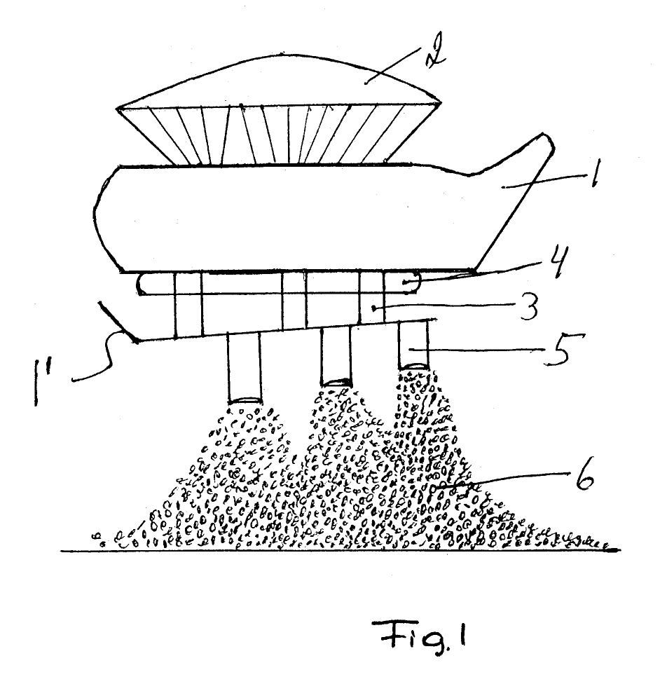

The impact preventing or reducing means shown in FIG. 1 include means for creating a pressure or a pressure wave under the body. In the embodiment of FIG. 1 they include a plurality of nozzles 5 located under the body 1 and operated for expelling a medium creating a pressure wave, for example air, oxygen, etc. Of course, in addition to the nozzles there is a source for expelling the medium under pressure, for example a compressor, etc. The medium 6 under the body of the aircraft creates a pressure wave which reduces the free fall of the aircraft. In addition, dampening elements or impact absorbing of various types can be located between the main body 1 of the aircraft and an additional bottom which is identified with reference numeral 1′. The additional bottom 1′ in a normal position can be coextensive with the bottom of the body 1, and also it can be introduced into a recess provided in the lower bottom of the body 1. The dampening or absorbing elements can be hydraulic, pneumatic, rubber-like, etc. In addition, an air cushion 4 is located under the bottom of the body 1 or between the bottom of the body 1 and the additional bottom 1′. Therefore, a multi-stage process is provided. First, the pressure wave of the medium 6 reduces the speed of free fall of the aircraft, then the additional bottom 1 moves upwardly during impact against the ground slower because of the dampening elements 3, and finally the air cushion 4 further reduces the impact. In addition, a parachute 2 can be attached to the aircraft at the top.

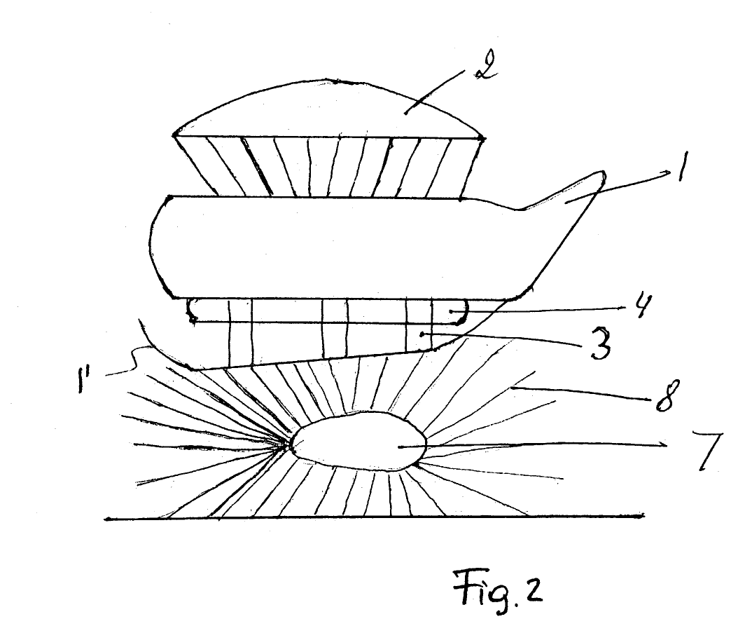

In the embodiment of FIG. 2, the aircraft 1 is also provided with dampening or absorbing element 3, the air cushion 4 and the parachute 2. In addition, an explosive element 7 can be located in the aircraft and during the fall thrown downwardly so as to explode and to create an explosive wave 8. The explosive wave 8 also reduces the speed of fall of the aircraft, while additional elements 2, 3, 4 assist in reducing the force of the impact.

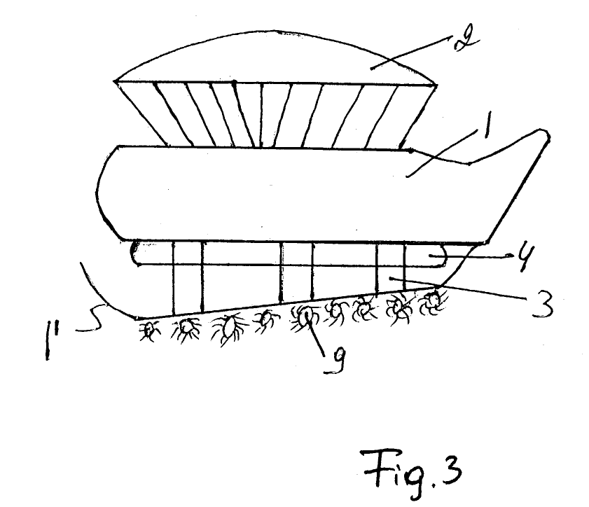

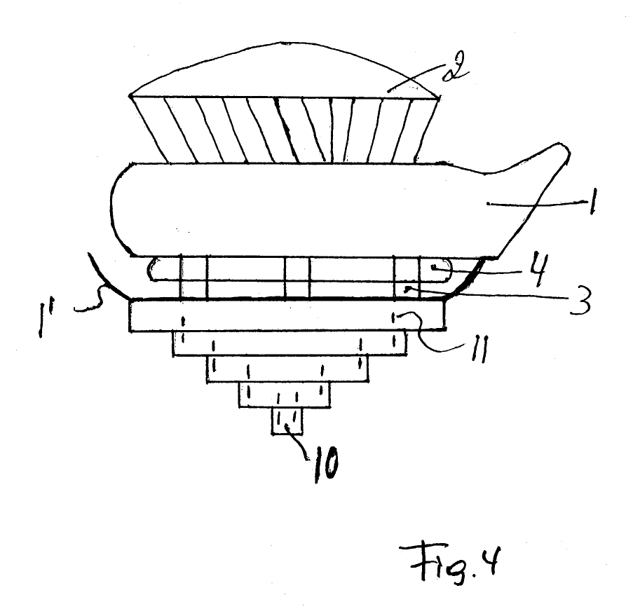

In the embodiment showing FIG. 3, the aircraft has the body 1, the parachute 2, a plurality of absorbing or dampening elements 3, and possibly an air cushion 4. The means for at least reducing impact against the ground includes a plurality of small explosive charges which can be stored initially in the aircraft and then expelled from the aircraft under the bottom 1′ to explode and to provide a plurality of sources of explosive waves, so as to reduce the speed of falling of the aircraft on the ground.

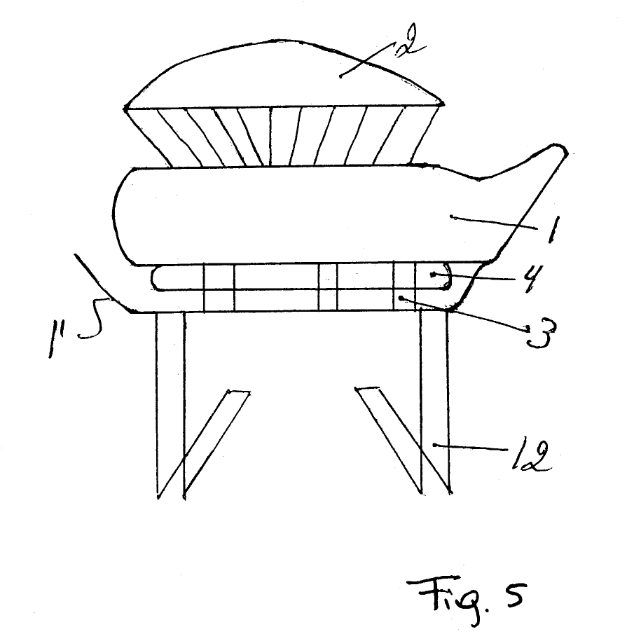

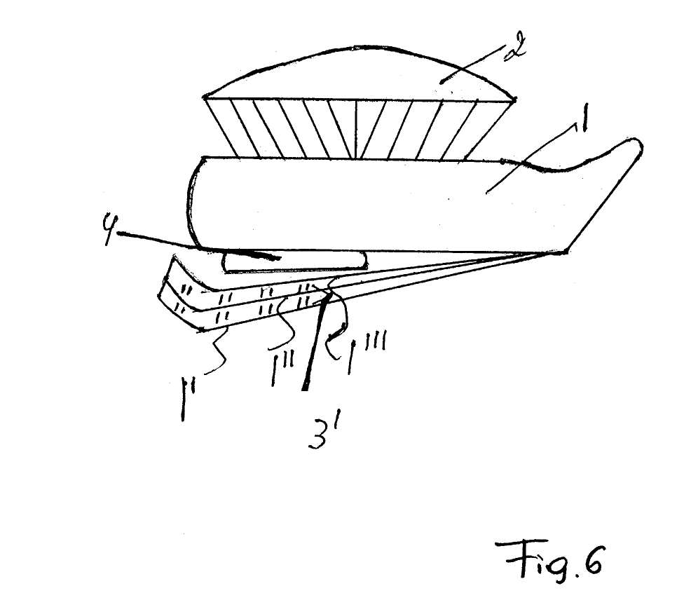

In the embodiment of FIG. 4, the aircraft that has a body 1 and is provided with a parachute 2, a plurality of dampening or absorbing elements 3 and an air cushion 4. In addition, under the additional bottom 1′ a plurality of elements 10 can be provided. The elements 10 can be formed as telescopical cylinders, hollow rectangles etc., which can be telescopically connected to one another so as to be folded together in an inoperative position and to be unfolded to reduce the impact of the aircraft against ground. A plurality of additional dampening or amortizing elements 11 can be provided between the elements 10. As a result, during impact of the aircraft against the ground the elements or steps 10 are subjected to impact 1 and are successively destroyed or to fold one after the other, with overcoming a resistance of the absorbers 11.

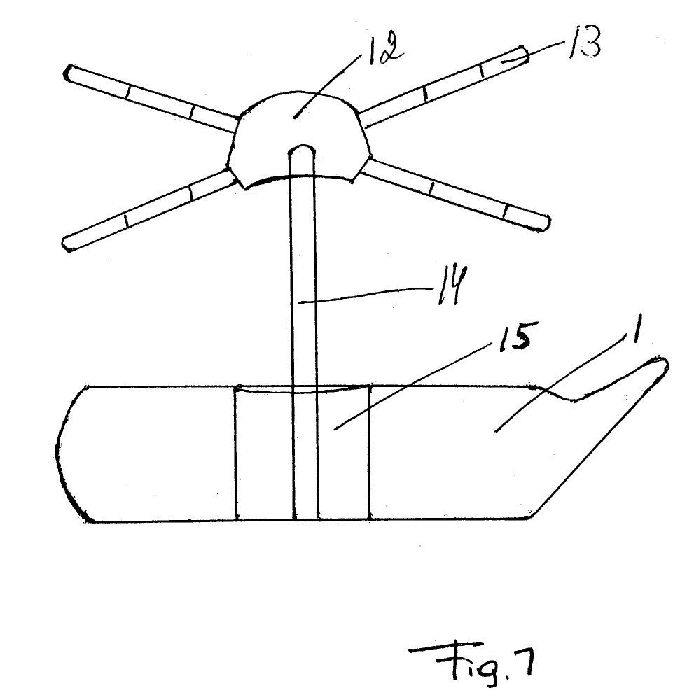

In the embodiment of FIG. 5, the aircraft has a body 1, parachute 2, a plurality of dampening or amortizing elements C and air cushion 4. In addition, it has a plurality of legs 12 located under the bottom of the aircraft or more particularly under the additional bottom 1′.

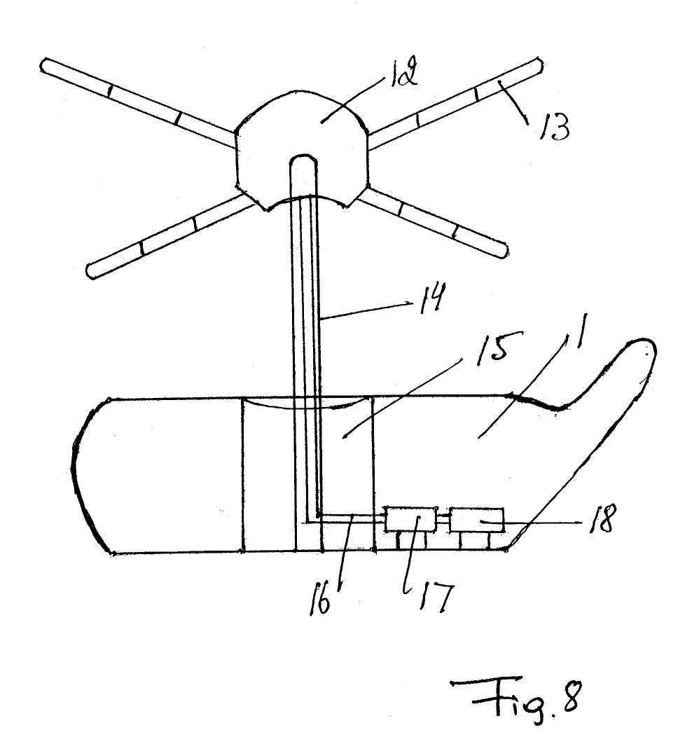

In the embodiment of FIG. 6, the aircraft has a body 1, a parachute 2 and a plurality of additional bottoms 1′, 1″, 1′″. The additional bottoms 1′, 1′, 1′″ in a normal position are folded together and stored either immediately under the main bottom of the body 1 or in a recess formed inside the body 1. A plurality of dampening or absorbing elements 3′ are located between the additional bottoms 1′, 1″, 1′″. In a dangerous situation, the additional bottoms are unfolded so as to be spaced from one another, for example pivoted relative to one another so that first the lower most additional bottom 1′ is subjected to an impact, and then subsequent additional bottoms, with dampening action of the dampening or absorbing elements 3′. An air cushion 4 can be also provided between the additional bottoms and the main bottom.

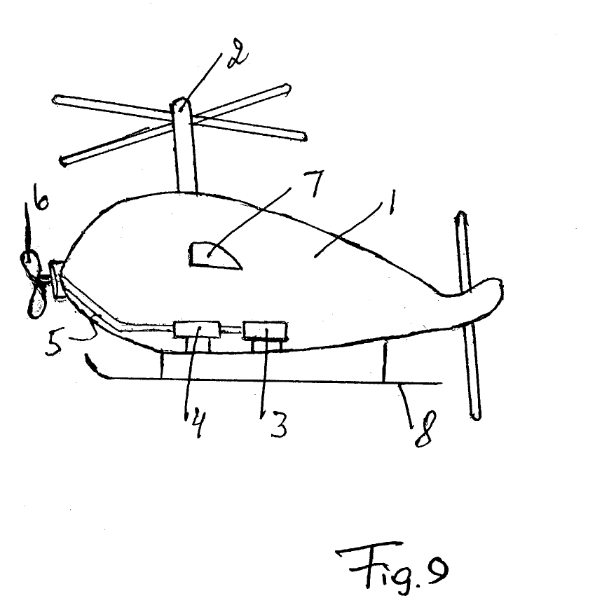

In the embodiment of FIG. 7, the aircraft having a body 1 is provided with additional means which convert it actually into a helicopter. In particular, it is provided with an impeller or a plurality of wings arranged on a shaft 14 and rotatable by a motor 17. In a normal situation the wings 13 are folded to occupy less space and the wings 13, together with the motor 17 and the shaft 14 are withdrawn Into a recess 15 in the body 1 of the aircraft. In the event of a danger of a crash, a corresponding switch is turned on and the shaft 14 with the wings 13 is displaced outwardly of the body 1, the wings 13 are unfolded, and the impeller with the plurality of wings start rotating so as to actually convert the aircraft 1 into a helicopter. Thereby, the crash is prevented.

It will be understood that each of the constructions described above, or two or more together, may also find a useful application in other types differing from the types described above.

While the invention has been illustrated and described as embodied, it is not intended to be limited to the details shown, since various modifications and structural changes may be made without departing in any way from the spirit of the present invention.

Without further analysis the foregoing will so fully reveal the gist of the present invention that others can, by applying current knowledge readily adapt it for various applications without omitting features that from the standpoint of prior art, fairly constitute essential characteristics of the generic or specific aspects of this invention.

What is claims as new and desired to be protected by Letters Patent is set forth in the appended claims:

1. An aircraft, comprising a body; means providing flying of the aircraft; and means for preventing or at least reducing chances of crash of the aircraft in the event of malfunction, said preventing and reducing means include means for preventing a direct hit of the body of the aircraft against a surface.

2. An aircraft as defined in claim 1, wherein said preventing means include means for creating a pressure by a medium under the aircraft.

3. An aircraft as defined in claim 2, wherein said preventing means include a plurality of nozzles through which the medium is expelled so as to create a pressure of the medium under the aircraft.

4. An aircraft as defined in claim 1, wherein said preventing means include explosive means which generate an explosion under the aircraft to create an explosion wave.

5. An aircraft as defined in claim 1, wherein said preventing means include a plurality of small explosive generating elements which explode under the aircraft to create explosive waves.

6. An aircraft as defined in claim 1, wherein said preventing means include a plurality of elements telescopically extendable from one another under the aircraft.

7. An aircraft as defined in claim 1, wherein said preventing means include a plurality of leg elements which are extendable under the body to withstand an impact when the aircraft lowers to the surface.

8. An aircraft as defined in claim 1; further comprising an additional bottom located under the bottom of the aircraft, said preventing means being located under said additional bottom.

9. An aircraft as defined in claim 8, wherein said additional bottom is placed under the bottom of said body.

10. An aircraft as defined in claim 8, wherein said additional bottom is introduceable into a cavity inside said body.

11. An aircraft as defined in claim 1, further comprising a plurality of additional bottoms located under a bottom of said body, said additional bottoms being moveable to be close to one another and also moveable farther from one another to withstand an impact during a lowering of the aircraft onto the surface.

12. An aircraft as defined in claim 11; further comprising dampening elements located between said additional bottoms.

13. An aircraft as defined in claim 1, wherein said preventing means include a helicopter-type propeller which during normal operation of the aircraft is introduceable into an interior of the body and in the event of possibility of crash is moveable outside of the body to operate as a helicopter propeller to hold the aircraft flying.

14. An aircraft as defiled in claim 13, wherein said impeller includes foldable vanes.

15. An aircraft as defined in claim 13, wherein said impeller includes a shaft which holds said wings and is moveable together with said vanes between a position inside the body and a position outside of the body.
